(19) United States
(12) Patent Application Publication
(10) Pub. No.: US 2007/0083721 A1
(43) Pub. Date: Apr. 12, 2007

(54) Memory management for a data processing system

(75) Inventor: Emmanuel Grinspan, Raanana (IL)

Correspondence Address: Siemens Corporation;Intellectual Property Department, 170 Wood Avenue South, Iselin, NJ, 08830, US

(73) Assignee: Siemens Aktiengesellschaft

(21) Appl. No.: 11/237,511

(22) Filed: Sep. 28, 2005

(51) Int. Cl. G06F 13/00; G06F 12/00; G06F 13/28

(52) U.S. Cl. 711/159

(57) ABSTRACT

A memory management for a data processing system is provided. According to one embodiment, a method for managing memory in a telephony device is provided. The method comprising providing a known time, providing an allocator having a time-to-release parameter, allocating memory via a call to the allocator, assigning a timer having a release time and associating the timer with the memory. The time-to-release indicating the release time, which is greater than the known time.

### FIELD OF THE INVENTION

The present invention relates to memory management in a data processing system, and more particularly, to releasing allocated memory after a release time.

### BACKGROUND

Memory management provides for the managing of memory in a data processing system. Among other things, memory management allows the allocation and release of memory within a variety of systems, such as a data processing system. Memory management may be done via software, hardware or combinations thereof.

One type of problem that can occur within a data processing system is a memory leak. A memory leak occurs when memory that has been allocated within a data processing system is no longer referenced but has not been released. Memory leaks can cause significant problems such as causing the data processing system to crash.

Tools, such as the Rational Purify software that is commercially available from the IBM Corporation of New York, can detect memory leaks. Typically these tools monitor allocation and release to detect a memory leak. Also, Some languages such as JAVA and C# have run time libraries with a garbage collector as part of the memory management. The garbage collector periodically cleans up memory that is no longer referenced due to a referencer that references the memory going out of scope. Examples of a referencer are variables and objects.

There exists a need for improved memory management.

### SUMMARY OF THE INVENTION

In one aspect of the present invention, a method for managing memory in a telephony device is provided. The method comprising providing a known time, providing an allocator having a time-to-release parameter, the time-to-release indicating a release time greater than the known time, allocating memory via a call to the allocator, assigning a timer having the release time and associating the timer with the memory.

In another aspect of the present invention, a device for memory management in a real-time system is provided. The device comprising an application, a first memory, and a second memory. The application has an allocator with a time-to-expire parameter. The first memory unit stores a memory allocated via the allocator. The second memory stores a timer. The allocated memory and timer having an association. The timer having a release time in accordance to the time-to-expire parameter.

Yet in another aspect of the present invention, a system for memory management in a real-time system is provided. The system comprising an application, a processor, a first memory, and a second memory. The application has an allocator with a time-to-expire parameter. The processor executes the application. The first memory unit stores a memory allocated via the allocator. A second memory stores a timer. The allocated memory and timer have an association. The timer has a release time in accordance to the time-to-expire parameter.

### BRIEF DESCRIPTION OF THE DRAWINGS

The above mentioned and other concepts of the present invention will now be described with reference to the drawings of the exemplary and preferred embodiments of the present invention. The illustrated embodiments are intended to illustrate, but not to limit the invention. The drawings contain the following figures, in which like numbers refer to like parts throughout the description and drawings wherein:

FIG. 1 illustrates an exemplary embodiment of an allocator having a time-to-release parameter in accordance to the present invention;

FIG. 2 illustrates an exemplary schematic of a memory management system in accordance to the present invention;

FIG. 3 illustrates another exemplary schematic of a memory management system in accordance to the present invention;

FIG. 4 illustrates an exemplary flow diagram for allocating a memory with an associated timer in accordance to the present invention;

FIG. 5 illustrates an exemplary flow diagram for releasing memory in accordance to the present invention;

FIG. 6 illustrates an exemplary flow diagram of a timer expirary in accordance to the present invention;

FIG. 7 illustrates an exemplary flow diagram of a secondary timer expirary in accordance to the present invention; and

FIG. 8 illustrates an exemplary flow diagram for releasing memory in accordance to the present invention.

### DETAILED DESCRIPTION OF THE INVENTION

The invention described herein may employ one or more of the following concepts. For example, one concept relates to an allocator having a time-to-release parameter. Another concept relates to an allocator as an overloaded method. Another concept relates to an intermediary with a referencer parameter and a time-to-release parameter. Still another concept relates to an absolute time. Yet another concept relates to a relative time.

The present invention is disclosed in context of use for a memory management in C++ for a real time device in a telephony system. The principles of the present invention, however, are not limited to use within C++ but may be used in other object oriented languages presently known or later developed, such as Fortran 2003, to manage memory. Additionally, the principles of the present invention are not limited to use within an object oriented language but may be applied to non object oriented languages presently known or later developed, such as C. The present invention is disclosed in context of using a ‘new’ as an allocator for allocating memory and in context of using a “delete” as a releasor for releasing memory. However, any suitable allocator that allocates memory, such as “alloc” may be used. Likewise, any suitable releasor that releases memory, such as ‘free’ may be use. Additionally, although the present invention is disclosed for use in a real-time telephony system, the present invention may be used in other real time systems or even non real time system. However, the present invention has particular applicability to real-time systems and moreover a particular applicability to real time-telephony systems.

Applicant has recognized that presently available tools, such as Rational Purify, merely monitor applications to detect memory leaks. If the tool detects a memory leak, a developer may modify the code, recompile and link, then redistribute the software for testing. In theory, the software should be completely retested but often in practice only the area of the software modified is retested. By not thoroughly testing or retesting the software memory leaks may go undetected. Additionally, some memory leaks are difficult to detect. For example, some memory leaks only occur when a specific combination of events occur. Although these tools are useful in detecting memory leaks, the tools do not prevent memory leaks.

Applicant has also recognized that garbage collection has it drawbacks. For example, garbage collection only releases memory where the referencer is no longer in scope. The referencer's scope is the region of a program to which the referencer can be referred, typically via a name. This is a problem where a referencer remains in scope until the program exits. Also, the garbage collection is done periodically and without being able to specify when to run the garbage collection. Garbage collection tends to be slow which may cause problems for a real time system. Additionally, not all languages, such as C and C++, have garbage collection. Real time refers to a processing in a time that would generally occur in real life. For example, in telephony voice should be transmitted without a depreciable delay as to mimic talking to someone in person. Another example would be in simulator for a tank wherein the display would be updated to reflect the simulated movement in the tank as though the tanks were really moving.

In some systems, particularly real time systems, the time it takes to process information may be known, referred herein after as “known time”. For example, in a telephone switch, the software signaling application might have a protection mechanism that will automatically reconnect the end-users in case of connection failure. This protection mechanism must reconnect the end-users within a minimum amount of time; otherwise, the connection will be disconnected. Thus, this minimum amount of time, which is the “known time”, is used to reconnect the end-users. In case the known time expires, the software signaling application will disconnect both end-users and all the memory allocated for the connection will be released.

By knowing the known time, a memory that is allocated in association to the information may be setup to be released after the known time. This is advantageous in avoiding memory leaks when the application did not release the memory via a delete. The time to release, referred herein after as “release time”, should be greater than the known time to provide the application adequate processing time. However, the time to release may be appreciatively greater or substantially greater than the known time. As used herein, the term “appreciatively greater” means at least 10% greater than the known time, and “substantially greater” means at least at least 50% greater than the known time. Furthermore, it may be desired to have a different time to release for different sizes of memory blocks. For example, it may be desirable have a time to release which is appreciatively greater than the known time for a larger block of memory, wherein it may be desirable to have a time to release which is substantially greater than the known time for a smaller block of memory.

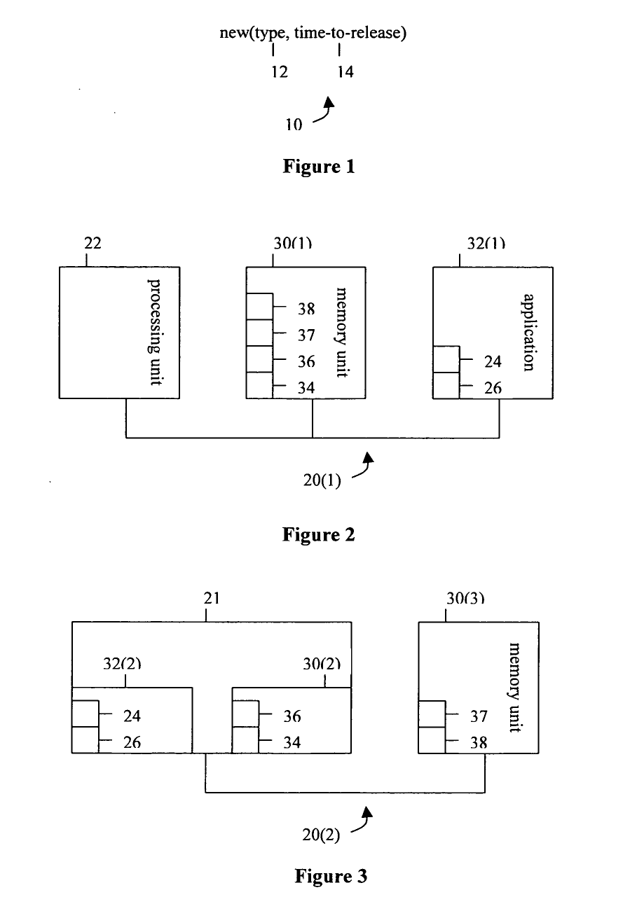

Referring to FIG. 1, an exemplary embodiment of an allocator having a time-to-release parameter 14 in accordance to the present invention is shown. FIG. 1 illustrates a new 10 having a type parameter 12 and a time-to-release parameter 14. The type parameter 12 indicates information for a memory to be allocated, for example, an object name or a size of memory. The time-to-release parameter 14 provides the release time to be associated with the allocated memory. The release time may be expressed as a relative time or an absolute time. Furthermore, the time-to-release parameter 14 could be provided as a date, which is a type of an absolute time. A system using the absolute time may need to include a real-time clock. The relative time is a release time relative to allocating the memory, e.g. a time after allocating the memory. The absolute time may indicate an hour and minute to release the memory, e.g. 2100, which is 9 PM.

The allocator may be an overloaded method, that is a method with the same name but a different set of parameters, as provided by an objected oriented language. However, the allocator may have a unique name instead of being an overloaded method.

An intermediary having a time-to-release parameter 14 may be used as an alternative to the allocator having a time-to-release parameter 14. The intermediary might be used, for example, when the language does not support overloading. When using the intermediary, the allocator allocates a memory. The intermediary having a reference to the allocated memory and the time-to-release parameter 14 provides the release time to be associated with the allocated memory. A reference refers to an address or any other suitable value that provides a way to obtain access to what is being referenced.

Now referring to FIG. 2, an exemplary schematic of a memory management system 20(1) in accordance to the present invention is provided. The memory management system 20(1) includes a processing unit 22, memory unit 30(1), and an application 32(1). The processing unit 22 is coupled to the memory unit 30(1) and the application 32(1). Throughout this document, the term “coupled” refers to any direct or indirect communication between two or more elements in memory management system 20, whether or not those elements are in physical contact with one another. Additionally, the application 32(1) is coupled to the memory unit 30(1).

A memory unit 30 is a hardware unit, such as a cache, a Random Access Memory (RAM), or a magnetic disk, that is capable of storing and retrieving information. The memory unit 30(1) may include a memory 36 and a timer 34. In another embodiment, the memory unit 30(1) may further include a list 37 and a secondary timer 38.

The application 32(1) is software having an allocator 24 and a releasor 26. The allocator 24 indicates allocation information as described above. The allocator 24 allocates a memory 36 in memory unit 30(1). Additionally, the allocator 24 allocates a timer 34 in memory unit 30(1) wherein the timer 34 is associated with the memory 36. The timer having a release time provided in accordance to the time-to-release parameter 14 in FIG. 1. The releasor 26 releases the memory 36 and timer 34 from memory unit 30(1).

The processing unit 22 is a hardware unit, such as a microprocessor, for executing the application 32(1). The processing unit 22 may further comprise volatile memory for use during the application 32(1) execution.

Now referring to FIG. 3, another embodiment of an exemplary schematic for a memory management system 20(2) wherein a portion of the memory management system 20 is embedded in a device 21 in accordance to the present invention is shown. In the exemplary embodiment, the memory management system 20(2) includes a device 21 and a memory unit 30(3) wherein he device 21 is coupled to the memory unit 30(3).

The device 21 is a hardware unit that includes a memory unit 30(2) and the application 32(2). The hardware unit is any suitable device that may allow a processing of the application 32(2) wherein the application 32(2) may be implemented using software, hardware or combinations thereof. For example, the device 21 may be a microprocessor, an Application-Specific Integrated Circuit (ASIC), a Field Programmable Gate Array (FPGA), and the like. The application 30(3) includes the allocator 24 and the releasor 26. The memory unit 30(2) includes the memory 36 and the timer 34.

The memory unit 30(3) includes include the list 37 and the secondary timer 38.

Those skilled in the art would recognize that there may be other embodiments for the memory management system 20. For example, the list 37 and the secondary timer 38 may be included in the memory unit 30(2) or that the memory 36 may be included in the memory unit 30(3).

Now referring to FIG. 4, an exemplary flow diagram for allocating a memory with an associated timer in accordance to the present invention is provided. After the allocator is called with the type parameter and the time-to-release parameter, memory is allocated in accordance with the type parameter 50. This may involve calling a constructor in the case of allocating an object. Additionally, a timer is assigned 52 in accordance to the time-to-release parameter. The assignment of the timer may include statically or dynamically allocating the timer. The timer assignment also may be handled within the constructor. Subsequently, the timer and the memory are associated 54. The association may include the memory having a timer reference, the timer having a memory reference, or combinations thereof.

FIG. 4 may also be used to describe the flow for using the intermediary as follows. After the allocator is called with the type parameter, memory is allocated in accordance with the type parameter 50. A timer is assigned 52 in accordance to the time-to-release parameter after the intermediary is called with a reference to allocated memory and the time-to-release parameter. Subsequently, the timer and the memory are associated 54.

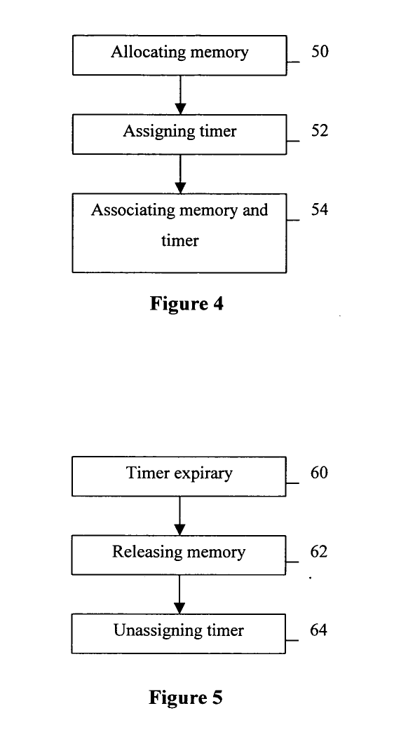

Now referring to FIG. 5, an exemplary flow diagram for releasing a memory due to a timer expiration in accordance to the present invention is provided. When the timer has reached or exceeded the release time, the timer expires 60. The timer uses the memory reference to release the allocated memory 62. The timer is also unassigned 64. The timer unassignment may also include releasing the timer.

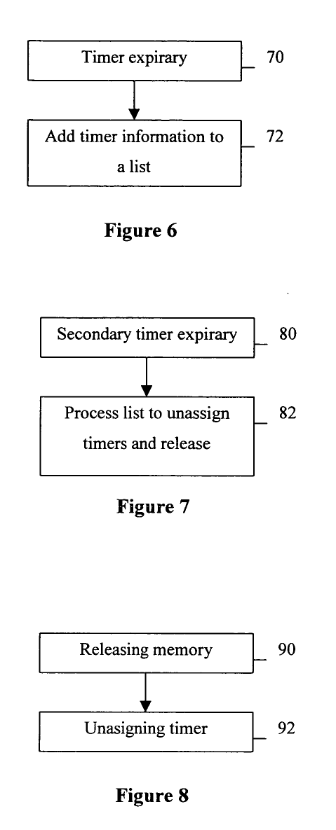

Now referring to FIGS. 6 and 7, alternative exemplary flow diagrams due to a timer expiration in accordance to the present invention is provided. When the timer expires 70, a timer reference may be added to the list 72. Then when a secondary timer expires 80, the list is processed to release the timers and the memory associated to the timers 82. Alternatively, a memory reference maybe added to the list and when the list is processed, the memory and the timers associated to the memory are released. The secondary timer may be a fixed value, configurable, or administrable.

Now referring to FIG. 8, an exemplary flow diagram for releasing memory due to a call to a releasor in accordance to the present invention is provided. An application may call to the releaser to release memory 90. The associated timer is unassigned 92.

While the invention has been described in terms of a certain preferred embodiment and suggested possible modifications thereto, other embodiments and modifications apparent to those of ordinary skill in the art are also within the scope of this invention without departure from the spirit and scope of this invention. Thus, the scope of the invention should be determined based upon the appended claims and their legal equivalents, rather than the specific embodiments described above.

1. A method for managing memory in a telephony device, comprising:
providing a known time;
providing an allocator having a time-to-release parameter, the time-to-release indicating a release time greater than the known time;
allocating memory via a call to the allocator;
assigning a timer having the release time; and
associating the timer with the memory.

2. The method according to claim 1, wherein associating the timer with the memory comprises:
providing a timer reference in the memory, and
providing a memory reference in the timer.

3. The method according to claim 2, further comprising expiring of the timer after a release time.

4. The method according to claim 3, further comprising:
releasing the memory, and
unassigning the timer.

5. The method according to claim 3, further comprising:
providing a secondary timer, and
adding a timer reference that references the timer to a list,
when the secondary timer expires,
releasing the timer and the associated memory for each timer reference in the list.

6. The method according to claim 3, further comprising:
providing a secondary timer, and
adding a memory reference that references the memory to a list,
when the secondary timer expires,
releasing the memory and the associated timer for each memory reference in the list.

7. The method according to claim 1, wherein the release time is appreciatively greater than the known time or wherein the release time is substantially greater than the known time.

8. A device for memory management in a real-time system, comprising:
an application having an allocator with a time-to-expire parameter;
a first memory unit for storing a memory allocated via the allocator; and
a second memory for storing a timer, the allocated memory and timer having an association, the timer having a release time in accordance to the time-to-expire parameter.

9. The device according to claim 8, further comprising a processor.

10. The device according to claim 8, wherein the release time is greater than a known time.

11. The device according to claim 10, wherein the release time is appreciatively greater than a known time or wherein the release time is substantially greater than the known time.

12. The device as according to claim 8, wherein the device is an Application-Specific Integrated Circuit (ASIC) or a Field-Programmable Gate Array (FPGA).

13. The device as according to claim 8, wherein the first and second memory units are the same memory unit.

14. The device as according to claim 8, wherein when the timer expires, the associated memory and the timer are released or wherein the application further includes a list and a secondary timer and when the timer expires a reference is stored in the list.

15. The device as according to claim 14, wherein when the secondary timer expires, the memory associated to the reference is released.

16. A system for memory management, comprising:
an application having an allocator with a time-to-expire parameter;
a processor for executing the application;
a first memory unit for storing a memory allocated via the allocator; and
a second memory for storing a timer, the allocated memory and timer having an association, the timer having a release time in accordance to the time-to-expire parameter.

17. The system according to claim 16, wherein the release time is greater than a known time.

18. The system as according to claim 16, wherein the first and second memory units are the same memory unit.

19. The system as according to claim 16, wherein when the timer expires, the associated memory and the timer are released or wherein the application further includes a list and a secondary timer and when the timer expires a reference is stored in the list.

20. The system as according to claim 19, wherein when the secondary timer expires, the memory associated to the reference is released.
